(19) United States
(12) Patent Application Publication
(10) Pub. No.: US 2012/0279741 A1
(43) Pub. Date: Nov. 8, 2012

(54) VARIATION OF THE NATURAL FREQUENCY OF VIBRATORY MEANS IN ELECTRIC TOOLS

(75) Inventors: Gerd Schlesak, Tamm (DE); Carsten Diem, Ludwigsburg (DE); Willy Braun, Neustetten (DE); Hardy Schmid, Stuttgart (DE); Holger Ruebsaamen, Stuttgart (DE); Michael Weiss, Stuttgart (DE); Jan Koalick, Leinfelden (DE); Peter Loehnert, Moessingen (DE)

(73) Assignee: ROBERT BOSCH GMBH, Stuttgart (DE)

(21) Appl. No.: 13/511,907

(22) PCT Filed: Oct. 6, 2010
(86) PCT No.: PCT/EP2010/064885

§ 371 Date: May 24, 2012

(30) Foreign Application Priority Data
Nov. 25, 2009 (DE) 10 2009 047 106.5

(51) Int. Cl. B25F 5/00

(52) U.S. Cl. 173/162.2

(57) ABSTRACT

An electric tool includes a vibratory means which is configured to impart a counteracting vibration which counteracts a housing vibration of the electric tool. A vibration-relevant characteristic of the vibratory means can be adapted during the operation of the electric tool in such a way that the amplitude, the phase position and/or the frequency of the counteracting vibration varies with a change in the vibration-relevant characteristic. The vibratory means of the electric tool has a natural frequency which can be varied by variation means of the electric tool. A method for compensating housing vibrations, in particular of the electric tool, includes imparting a counteracting vibration by a vibratory means which counteracts a housing vibration of the electric tool. The amplitude, the phase position and/or the frequency of the counteracting vibration is varied during the operation of the electric tool.

### PRIOR ART

The present invention relates to an electric tool having a vibratory means, which is arranged in the electric tool in order to compensate for housing vibration, and to a method for compensation for housing vibration of an electric tool.

As a result of the legal requirement coming into force that, when using electric tools, the daily permissible workload must be coupled to the physical load acting on the operator, the subject of vibration of electric tools, in particular of hammer drills and percussion hammers, is becoming of ever greater importance.

When hammer-drilling and chiseling using a hammer, the housing vibration produced by the hammer mechanism results in a very major physical load on the operator. Particularly in the case of large hammer drills and percussion hammers, the high percussion energy results in the vibration being very pronounced. Without further measures, the permissible working time for operators of machines such as these is therefore in some cases considerably reduced. As a consequence of this, development effort is increasingly being applied to solutions in which vibration of electric tools is reduced. This makes it possible to ensure that it will still be possible to continue to work with appliances such as these without any restriction.

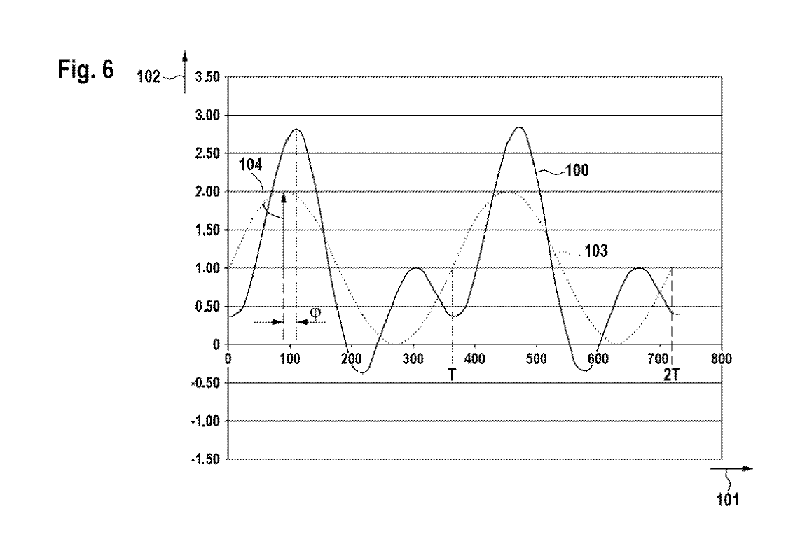

FIG. 6 shows a typical housing vibration 100 which occurs in the vibration of the housing of hammer drills and percussion hammers 7, caused by a hammer mechanism assembly 8 in which the striker 121 is driven by an eccentric piston drive 12. The revolution angle is shown [in °] on the horizontal axis 101, and the deflection [in mm] of the housing is shown on the vertical axis 102. The housing vibration 100 which generates vibration is composed of a plurality of frequency components. The main frequency is derived from the periodic acceleration of the striker 121. However, FIG. 6 shows that the deflection which is caused by the periodic acceleration of the striker 121 also has further frequency components superimposed on it from other vibration sources, for example from the impact and reaction processes in the hammer chain and from unbalanced mass forces in the drive. This is because the housing vibration 100 does not have an essentially sinusoidal profile at the main frequency, but further frequency components are superimposed on the sinusoidal profile at the main frequency.

Since non-linear systems operate with movement sequences which are harmonic only to a limited extent, the individual vibration components are superimposed in a complex manner. Non-harmonic complex-order housing vibration results from play between the individual components, non-linear elasticity profiles, the non-linear impact processes and the reaction forces, which are only approximately harmonic, from the hammer mechanism.

An optimum reduction in the housing vibration is achieved if a vibration reduction system counteracts as exactly as possible the housing vibration illustrated in FIG. 6.

In practice, opposing forces which counteract the housing vibration are produced, for example, with the aid of vibration absorbers.

A vibration absorber is a spring-and-mass system with a fixed resonant frequency which makes it possible to achieve a significant reduction in the vibration only in a narrow range close to the resonant frequency. The vibration-absorber natural frequency is therefore chosen to be as close as possible to the greatest disturbing vibration frequency of the housing, such that the vibration absorber acts as effectively as possible in this frequency range.

However, the vibration which occurs during operation of an electric tool normally originates from various sources. Their superimposition results in housing vibration at a different and variable frequency.

By way of example, when the load parameters and/or the operating parameters of the electric tool are changed, in particular as a result of a change in the rotation speed of the drive motor of the electric tool or when machining a workpiece composed of different materials, as occurs regularly during operation of the electric tool, the effective range of a vibration absorber can be overshot, with the vibration absorber therefore becoming ineffective.

Therefore, additional measures are required to improve the effect of the vibration absorber during the operating and load states that occur, and to achieve as great a reduction in vibration as possible.

### DISCLOSURE OF THE INVENTION

The object of the invention is therefore to provide an electric tool which is better matched to the changing requirements in the electric tool such that the housing vibration of the electric tool can be reduced more effectively, as well as a method for reduction of the housing vibration of the electric tool.

The object is achieved by an electric tool having a vibratory means, wherein the vibratory means is provided in order to exert an opposing vibration which counteracts a housing vibration of the electric tool, in which case a vibration-relevant characteristic of the vibratory means can be adapted during operation of the electric tool such that the amplitude, the phase angle and/or the frequency of the opposing vibration is varied in the event of a change in the vibration-relevant characteristic.

Since, according to the invention, the amplitude, the phase angle and/or the frequency of the opposing vibration of the vibratory means is changed during operation by adaptation of the vibration-relevant characteristic of the vibratory means, the opposing vibration is dynamically matched to the vibration conditions in the electric tool. This increases the frequency range in which the vibratory means can be used effectively to compensate for the housing vibration. It is therefore effectively possible to compensate for the housing vibration of the electric tool over a wider frequency range.

In one preferred embodiment, the electric tool has change means by means of which the amplitude the phase angle and/or the frequency of the opposing vibration can be changed during operation of the electric tool. This allows the opposing vibration of the vibratory means to be dynamically matched to the housing vibration during operation of the electric tool, such that the amplitude, phase angle and/or frequency of the opposing vibration can be changed such that it more exactly counteracts the housing vibration, even in the event of unexpected changes in the housing vibration, for example as a result of material changes in the workpiece. The housing vibration can therefore be counteracted better even when the operating and environmental parameters change.

Preferably, the housing vibration can be compensated for both as a function of the instantaneous operating state of the electric tool and independently of the operating point of the electric tool. The electric tool according to the invention therefore makes it possible to take account both of the operating settings and operating parameters of the electric tool, as well as of changes in the workpiece being machined, or in the behavior of the operator.

In one preferred embodiment, which likewise achieves the object, the vibratory means has a natural frequency which can be changed by the change means. The natural frequency of the vibratory means is a vibration-relevant characteristic. A person skilled in the art is aware that the natural frequency is that frequency of a vibratory means at which the vibratory means would vibrate when stimulated once, if the vibration were not damped by fiction and no exciting forces force the mass to vibrate. A person skilled in the art is likewise aware that the natural frequency of a mass-and-spring system is calculated using the following formula:

ω₀=√k_{F}/m

In this case, k_{F} is the spring constant of the spring, m is the weight of the mass, and ω₀ is the natural frequency of the mass-and-spring system.

If the frequency of a vibration which excites the vibratory means is close to the natural frequency of the vibratory means, the vibratory means vibrates with a very large amplitude. If the opposing vibration counteracts the housing vibration as exactly as possible, an essentially maximum magnitude of the housing vibration can therefore be compensated for by a frequency of the vibratory means close to its natural frequency. Primarily, changing the natural frequency of the vibratory means makes it possible to change the amplitude and, at least to a minor extent, also the phase angle of the opposing vibration. If the mass of the vibratory means changes, the frequency of the opposing vibration also changes.

In order to change the natural frequency of the vibratory means, the vibratory means preferably has a mass which can be changed. The mass is provided for a free opposing vibration, which counteracts the housing vibration and the vibration which causes the housing vibration. In one preferred embodiment, the mass comprises at least two mass elements which can be reversibly coupled to one another by the change means. The weight of the vibrating mass of the vibratory means can thus be changed, with the change in the weight of the vibrating mass leading to the change in the natural frequency. To be precise, when the weight of the mass increases, the natural frequency of the vibratory means is shifted in the direction of lower frequencies. In addition, the mass of the vibratory means is therefore a vibration-relevant characteristic.

Preferably, the vibratory means has a spring constant which can be changed by the change means. Particularly preferably, the vibratory means has a spring characteristic which is non-linear. The spring constant and the spring characteristic of the spring in the vibratory means are therefore vibration-relevant characteristics of the vibratory means.

In one preferred embodiment, the mass is arranged on at least one spring, in particular a spiral spring, a helical compression spring or a leaf spring. In this embodiment, the vibratory means is a vibration absorber.

In a further preferred embodiment, the vibratory means has a plurality of springs, which are connected to one another such that the spring characteristic of the vibratory means is non-linear. In one particularly preferred embodiment, the vibratory means has the spring on which the mass is arranged, as well as at least one second spring, which interacts with the spring as a function of the amplitude of the opposing vibration. The second spring is preferably connected in parallel with the spring such that the spring constant is increased. In a further preferred embodiment, both springs with a linear spring characteristic and springs with a non-linear spring characteristic are connected to one another.

It is self-evident to a person skilled in the art that the spring constant of the vibratory means is the spring constant of the spring or the spring constant which results from the plurality of springs in the vibratory means being connected in series and/or in parallel. A person skilled in the art knows that a spring characteristic reflects the profile of the spring constant which results from the quotient of the magnitude of the force stretching the spring, which is also referred to as the spring prestressing, and the lengthening produced by the stretching force. The spring characteristic of the vibratory means is therefore likewise the spring characteristic of the spring in the vibratory means, or the spring characteristic which results from the springs in the vibratory means being connected in series and/or in parallel. The change in the spring constant results in a change in the natural frequency of the vibratory means. To be precise, when the spring constant increases, the natural frequency of the vibratory means is shifted in the direction of higher frequencies.

In a likewise preferred embodiment, the spring prestressing of the vibratory means can be changed by the change means. In this case, both springs with a linear characteristic and springs with a non-linear spring characteristic are preferred.

It is self-evident to a person skilled in the art that the spring prestressing of the vibratory means is the spring prestressing of the spring or the spring prestressing which results from the plurality of springs in the vibratory means being connected in series and/or in parallel. In particular, the change in the spring prestressing results in a change in the amplitude of the opposing vibration. The spring prestressing is therefore a vibration-relevant characteristic of the vibratory means.

Preferably, the spring of the vibratory means is borne at a bearing point, in which the case the bearing point of the spring can be shifted by the change means to change the spring prestressing. The prestressing of the spring can be changed by shifting the bearing point of the spring, thus resulting, in particular, in a change in the amplitude of the opposing vibration.

In one preferred embodiment, the change means comprise an electrical control means, which interacts with the vibratory means, in particular with the mass and/or with the spring. Particularly preferably, the electrical control means interacts directly with the mass and/or the spring. Alternatively, it likewise preferably interacts indirectly with the mass and/or the spring, for example by activating or operating a further change means, which interacts directly with the mass and/or the spring. This makes it possible to provide open-loop or closed-loop electrical control for the change in the amplitude, frequency and/or phase angle of the opposing vibration. A person skilled in the art understands that a different form of open-loop or closed-loop control can also be used, for example mechanical open-loop or closed-loop control.

The electrical control means is preferably an actuator, or the control means likewise preferably comprises an actuator, in particular an actuating motor, a linear motor or an electromagnet.

In one preferred embodiment, the electric tool furthermore comprises a detection means for detection of the housing vibration of the electric tool, the rotation speed and/or the speed of rotation of a drive motor of the electric tool, the opposing vibration of the mass, and/or further vibration-relevant variables, such that the amplitude, the phase angle and/or the frequency of the opposing vibration of the mass can be changed as a function of these vibration-relevant variables. By way of example, acceleration sensors and/or position measurement sensors are used as detection means.

Preferably, the electric tool furthermore comprises an evaluation unit, which is connected to the detection means in order to evaluate the vibration-relevant variables, and in order to provide the control means with an output signal which is dependent on the vibration-relevant variables. An evaluation unit such as this preferably comprises logic which can be used to convert the vibration-relevant variables to the output signal. The vibration-relevant variables are preferably analyzed by comparison with standard variables. However, intelligent open-loop or closed-loop control, in particular adaptive closed-loop control, can likewise preferably be used as logic. By way example, the evaluation unit is a processor-controlled unit. However, it may also be an electrical circuit, in particular an integrated circuit, for example in the form of an ASIC (application-specific integrated circuit).

The open-loop or closed-loop control of the opposing vibration of the vibratory means by an electrical control means, and in particular as a function of vibration-relevant variables, allows the opposing vibration to be deliberately dynamically matched to the vibration level, to be precise both as a function of the instantaneous operating state of the electric tool and as a function of the known dynamic response of the electric tool in its various operating modes, and as a function of the behavior of an operator or as a function of the machining and/or the characteristics of the workpiece.

The object is also achieved by a method for compensation for housing vibration of an electric tool according to the invention, in particular, having a vibratory means which is provided in order to exert an opposing vibration which counteracts the housing vibration, in which case the amplitude, the phase angle and/or the frequency of the opposing vibration are changed during operation of the electric tool.

The amplitude, phase angle and/or frequency of the opposing vibration are/is preferably changed by adaptation of a vibration-relevant characteristic of the vibratory means.

This increases the effective frequency range of the vibratory means. Furthermore, actively changing the amplitude, phase angle and/or frequency of the opposing vibration allows the opposing vibration to be matched to the housing vibration which varies during operation of the electric tool. The opposing vibration can therefore be optimized during operation of the electric tool such that it counteracts the housing vibration more precisely, and thus compensates for it better.

The invention will be described in the following text with reference to figures. The figures are merely exemplary and do not restrict the general idea of the invention.

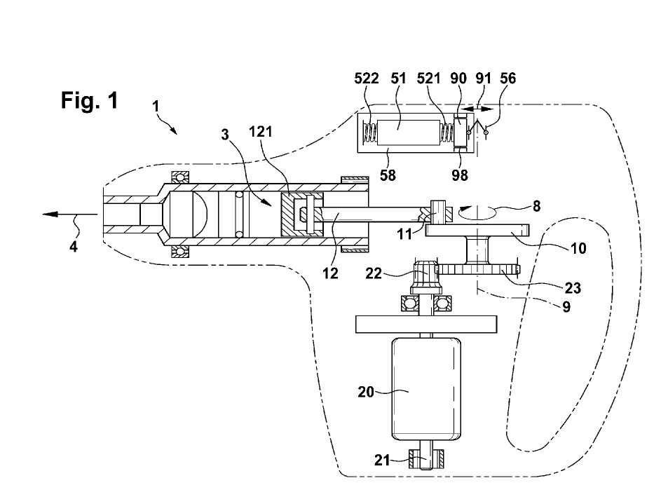

FIG. 1-FIG. 5 schematically show various embodiments of an electric tool according to the invention,

FIG. 6 shows a housing vibration of an electric tool as well as an opposing vibration of a vibratory means, and

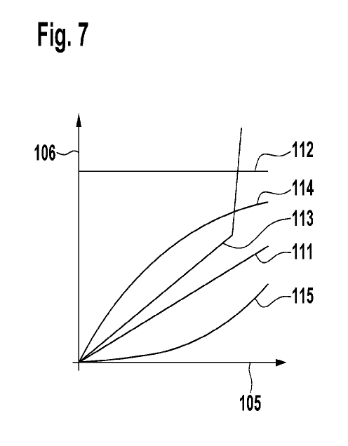

FIG. 7 shows spring characteristics of springs of different design.

FIG. 1-FIG. 5 schematically show various embodiments of an electric tool 1 according to the invention.

By way of example, a hammer drill is shown here as the electric tool 1, and comprises a hammer mechanism assembly 3. A striker 121 is provided in the hammer mechanism assembly 3 and is driven linearly via a connecting rod 12, which is borne eccentrically by means of an eccentric pin 11 on an eccentric disk 10 which rotates about an eccentric shaft 9.

The eccentric disk 10 can be driven by means of a gearwheel 23, which can likewise rotate about the eccentric shaft 9 and engages with a drive pinion 22, which is arranged such that they rotate together on a drive shaft 21 of a drive motor 20 of the electric tool 1. When the eccentric disk 10 rotates in a rotation direction 8 about the eccentric shaft 9, the striker 121 of the hammer mechanism assembly 3 is moved backward and forward in a longitudinal direction 4.

However, the present invention is not restricted to electric tools 1 having a hammer mechanism assembly 3, but can also be used for other electric tools 1, for example for drilling machines, jigsaws or the like.

In the following text, the term hammer drill is used synonymously for the electric tool 1.

According to the invention a vibration-relevant characteristic ω₀, 51, k_{F}, 112-115, 106, 52 of a vibratory means 58 is adapted during the operation of the electric tool 1 such that the amplitude 104, the phase angle φ and/or the frequency 1/T of an opposing vibration 103 executed by the vibratory means 58 is varied. By way of example, vibration-relevant characteristics ω₀, 51, k_{F}, 112-115, 106, 52 of the vibratory means 58 are their natural frequency ω₀, the spring prestressing 106, the spring constant k_{F} or spring characteristic 112-115 of their spring 52 and their mass 51. In this case, the vibration-relevant characteristics ω₀, 51, k_{F}, 112-115, 106, 52 of the vibratory means 58, when there are a plurality of springs 52, 521-524 and/or masses 51, 511, 512 connected to one another, are the vibration-relevant characteristics ω₀, 51, k_{F}, 112-115, 106, 52 which result from the plurality of springs 52, 521-524 and/or masses 51, 511, 512 being connected in series and/or in parallel.

In the embodiment shown in FIG. 1, a vibratory means is provided, which comprises a mass 51. The vibratory means furthermore comprises a first spring 521 and a second spring 522, with the mass 51 being arranged between the first spring 521 and the second spring 522. The vibratory means 58 is therefore a vibration absorber. In this case, spiral springs are provided as the first and second springs 521, 522. Therefore, the term spiral spring is therefore used synonymously to the term spring 521, 522 for the purposes of the description relating to FIG. 1.

Change means 98, 90, 56 are provided in the electric tool 1 and can be used to change the spring prestressing of the vibratory means 58. To be precise, a shifter 90 in a slotted-link guide 98 is provided as the change means, with the first spring 521 being borne on the shifter 90, such that the latter forms a bearing point for the first spring 521. The terms bearing point and shifter 90 are therefore used synonymously for the purposes of the description relating to FIG. 1.

A centrifugal-force weight arrangement 56, which interacts with the shifter 90, is provided as a further change means 98, 90, 56. The centrifugal-force weight arrangement 56 is connected to the eccentric shaft 9 such that they rotate together, as a result of which the centrifugal-force weight arrangement 56 can be driven by rotation of the eccentric shaft 9. In this case, the shifter 90 is shifted along the slotted-link guide in an extent direction 91. In the present case, the extent direction 91 is the extent direction 91 of the first and second springs 521, 522, such that the shifter 90 is shifted in the same direction as or in the opposite direction to the force of the first and second spiral springs 521, 522, thus changing the spring prestressing of the two springs 521, 522.

The shift in the bearing point 90 results in a change in the spring prestressing 106 of the vibratory means 58, thus in particular, changing the amplitude 104 of an opposing vibration 103 of the vibratory means 58. In this embodiment, the spring prestressing 106 is increased as a function of the rotation speed of the drive motor 20, to be precise, when using springs 521, 522 with a rising spring characteristic, with the spring prestressing 106 becoming greater the faster the rotation of the drive motor 20. This reduces the amplitude 104 of the opposing vibration 103. The use of a spring 521, 522 with a non-linear spring characteristic (see FIG. 7), preferably with a progressive spring characteristic 115, also makes it possible to prevent the mass 51 from striking its mechanical limit position. The mechanical limit position is reached when the springs 521, 522 cannot be compressed any more. Striking of the mechanical limit position would lead to an adverse effect on the operation and the life of the vibratory means 58.

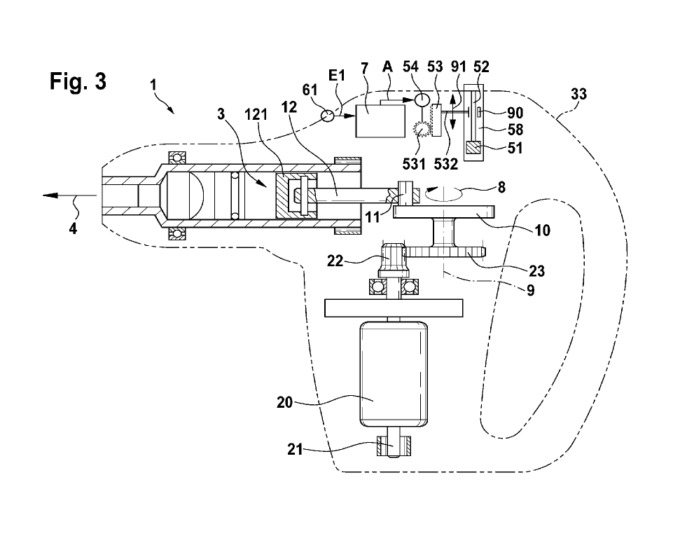

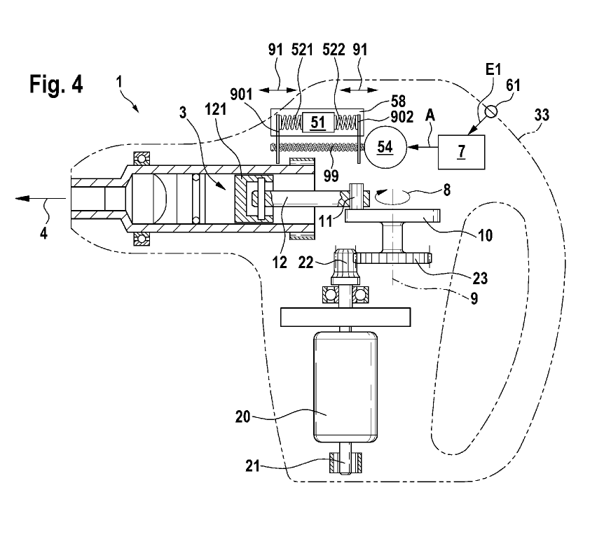

An embodiment is also feasible in which an electrical control means 54 (see, for example, FIGS. 3 and 4) is used to drive the centrifugal-force weight arrangement 56.

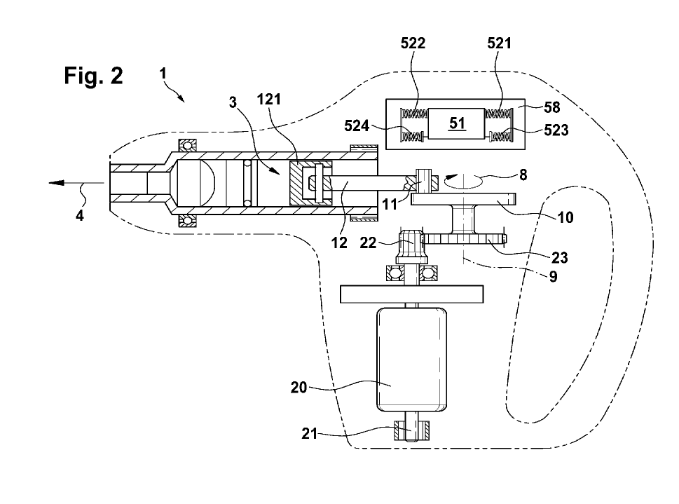

In the embodiment shown in FIG. 2, striking of the mechanical limit position is prevented by suspending the mass 51 of the vibratory means 58 between a first spiral spring 521 and a second spiral spring 522, with the first spiral spring 521 having a third spiral spring 523 arranged in parallel with it and the second spiral spring 522 having a fourth spiral spring 524 arranged in parallel with it, these interacting with the first and second spiral springs 521, 522 as a function of the amplitude 104 of the opposing vibration 103. When the amplitude 104 of the opposing vibration 103 is large, either the first spiral spring 521 and the third spiral spring 523 are connected in parallel, such that the spring constants k_{F521}, k_{F522} of the springs 521, 523 are added and the spring constant k_{F}of the vibratory means 58 is thus increased. This shifts the natural frequency ω₀ of the vibratory means 58 toward higher frequencies. Alternatively, the second spiral spring 522 is arranged in parallel with the fourth spiral spring 524, with the same result. Shifting the natural frequency ω₀ toward higher frequencies results in a reduction in the amplitude 104 of the opposing vibration 103.

In this embodiment, no further change means are provided in the electric tool 1.

In the embodiment shown in FIG. 3, a mass 51 of a vibratory means 58 is arranged on a leaf spring 52 of the vibratory means 58. The terms leaf spring and spring 52 are therefore used synonymously for the purposes of the description of the figure relating to FIG. 3.

In this case, the hammer drill 1 has a detection means 61 for detection of vibration-relevant variables E1, by means of which the housing vibratory 100 of the hammer drill 1 can be detected. The detection means 61 is therefore, for example, an acceleration sensor or a position measurement sensor. Alternatively or additionally, it is, however, possible to use the detection means 61 or further detection means E1 to detect other vibration-relevant variables E1, for example the rotation speed and/or the rotation angle of the drive motor 20 of the hammer drill 1, in which case, by way of example, conventional rotation-speed and/or rotation-angle sensors can be used for this purpose, for example commutation sensors, rotation-speed sensors, resolvers, position sensors and others. Further vibration-relevant variables E1 are, for example, also the current movement of the mass 51 and/or settings which can be changed by the operator.

The detected vibration-relevant variables E1 are transmitted for evaluation to an evaluation unit 7 which is connected to the detection means 61. The evaluation unit 7 comprises logic by means of which the vibration-relevant variables E1 can be converted to an output signal A, which is provided for an electrical control means 54. In this embodiment of the electric tool 1, the electrical control means 54 is therefore provided as a change means 54, such that the opposing vibration 103 of the vibratory means 58 can in this case be actively matched to the requirements in the electric tool 1.

In the embodiment shown in FIG. 3, an actuating motor is provided as the control means 54. This is also the case in the embodiment shown in FIG. 4, as a result of which the terms control means 54 and actuating motor are used synonymously in these FIGS. 3, 4.

In FIG. 3, a bearing point 90 of the leaf spring 52, in this case a clamping-in point 90, can be shifted by means of the actuating motor 54. Therefore, the terms bearing point 90 and clamping-in point 90 are used synonymously in FIG. 3. The mass 51 is arranged at one end of the leaf spring 52, while the other end of the leaf spring 52 is borne on the housing 33 of the electric tool 1. The mass 51 is therefore provided such that it can be used to produce an opposing vibration 103, which counteracts and at least partially compensates for the housing vibration 100.

The actuating motor 54 drives a gearwheel 531 which interacts with a toothed slide 53. When the gearwheel 531 rotates, the slide 53 is shifted along an extent direction 91 of the leaf spring 52. A clamping-in means 532 is arranged on the slide 53 and forms the clamping-in point 90 for the leaf spring 52, as a result of which the clamping-in point 90 of the leaf spring 52 is shifted when the slide 53 is shifted.

Therefore, in the embodiment shown in FIG. 3, the actuating motor 54 does not interact directly with the mass 51 and/or the leaf spring 52, but further change means 53, 531, 532 are provided, in this case a gearwheel 531, a slide 53 and a clamping-in means 532, which interact with the leaf spring 52.

Changing the clamping-in point 90 changes the spring constant k_{F}of the leaf spring 52 and therefore the natural frequency ω₀ of the vibratory means 58, such that, in particular, the amplitude 104 of the opposing vibration 103 is changed. Since the effective length of the leaf spring 52 is changed in this case, the shift also results in a change in the frequency 1/T of the opposing vibration 103.

In the embodiment shown in FIG. 4, in contrast to the embodiment shown in FIG. 3, the mass 51 is suspended between a first spiral spring 521 and a second spiral spring 522, with the first spiral spring 521 being borne on a first bearing means 901, and the second spiral spring 522 being borne on a second bearing means 902. The first bearing means 901 and the second bearing means 902 can be shifted backward and forward along a spindle 99 in the extent direction 91 of the first and second spiral springs 521, 522.

The spindle 99 can be rotated by means of the actuating motor 54, such that the first and the second bearing means 901, 902 are shifted along the extent direction 91. Embodiments are also possible in which the first and second bearing means 901, 902 can be shifted separately from one another.

The shift in the bearing means 901, 902 changes the spring prestressing 106 (see FIG. 7) of the spiral springs 521, 522, as a result of which, in particular, the amplitude 104 of the opposing vibration 103 is changed. In this embodiment, the bearing means 901, 902, the spindle 99 and the actuating motor 54 are change means 54, 99, 901, 902.

The use of springs 521, 522 with a non-linear and, in particular, progressive spring characteristic 115 (see FIG. 7) also makes it possible to prevent the mass 51 from striking its mechanical limit position in this case.

In addition, the use of springs 521, 522 with a non-linear spring characteristic (see FIG. 7) results in a dynamic change to the spring constant k_{F} and therefore in a change to the natural frequency ω₀ of the vibratory means 58. This allows the vibratory means 58 to be used effectively for a broader frequency band.

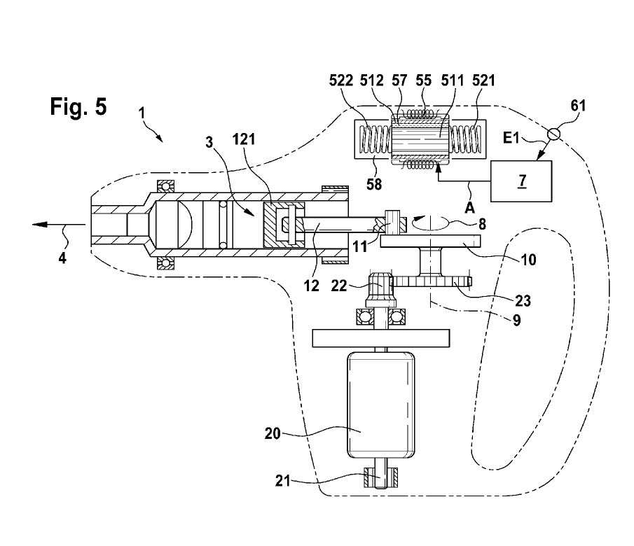

In the embodiment shown in FIG. 5, an electromagnet is provided as the control means 55. Therefore, the terms control means 55 and electromagnet are used synonymously in this FIG. 5.

In this embodiment, a first mass element 511 is suspended between a first spiral spring 521 and a second spiral spring 522. Furthermore, a second mass element 512 is provided, and is arranged in the area of the first mass element 511. By way of example, the second mass element 512 extends at least partially along the first mass element 511 or, for example, is arranged around it. A magnetorheological liquid 57 is arranged between the first mass element 511 and the second mass element 512, for example in a gap (not shown here).

An electromagnet 55 is arranged as the actuating means 55 in the area of the mass elements 511, 512 such that, when the electromagnet 55 is switched on, the magnetorheological liquid 57 results in the second mass element 512 being coupled to the first mass element 511, thus changing the weight of the mass 51. This is because when the electromagnet 55 is not switched on, the weight is essentially the weight of the first mass element 511, and when the electromagnet 55 is switched on, it is essentially the weight of the first mass element 511 plus the weight of the second mass element 512, as a result of which, in which the mass 51 is the first mass element 511 in the first case, and, in the second case the mass 51 is formed from the first mass element 511 and the second mass element 512.

This embodiment therefore has the electromagnet 55 as well as the magnetorheological liquid 57 as change means 55, 57, as a result of which, in this case as well, active open-loop or closed-loop control can be provided for the opposing vibration 103 of the vibratory means 58.

The greater weight causes a shift in the natural frequency ω₀ of the vibratory means 58 to lower frequencies, thus changing both the amplitude 104 and the phase angle φ as well as the frequency 1/T of the opposing vibration 103 of the vibratory means 58.

Mechanical controllers can also be used for open-loop or closed-loop control of the amplitude 104, phase angle φ and/or frequency 1/T of the opposing vibration 103 of the vibratory means 58. For example, it is possible to arrange the mass elements such that the mass elements 511, 512 are coupled by means of a bolt, which engages in retaining openings in the mass elements 511, 512, as a function of a vibration-relevant variable, such that, when the mass elements 511, 512 are coupled to one another, they form the mass of the vibratory means 58, while, when the mass elements 511, 512 are not coupled, only one of the two mass elements 511, 512 forms the mass 51 of the vibratory means 58.

FIG. 6 shows a housing vibration 100 of an electric tool 1 as well as an opposing vibration 103 of a mass 51, which is provided in the electric tool 1 in order to compensate for the housing vibration 100.

Since a housing vibration 100 is caused by a multiplicity of vibration sources, for example by the hammer action of a hammer mechanism assembly 3, from the impact and reaction processes in the hammer chain, by unbalanced mass forces in the drive and so on, the profile of the housing vibration 100 is not essentially sinusoidal. Instead, as is shown in FIG. 6, the housing vibration 100 comprises a multiplicity of sinusoidal forms of vibration with different amplitudes, phase angles and frequencies.

The housing vibration 100 can therefore be compensated for only partially by an essentially sinusoidal opposing vibration 103. However, the effectively usable frequency range of a vibratory means 58 can be optimized by changing the natural frequency wₒ of the vibratory means 58 and/or the accuracy with which the opposing vibration 103 of the housing vibration 100 is counteracted by adaptation of the phase angle φ, amplitude 104 and/or frequency 1/T of the opposing vibration 103, thus allowing more effective and better compensation for the housing vibration 100.

By way of example, FIG. 6 shows a sinusoidal opposing vibration 103 which, for example, is produced by a mass 51 which is suspended on a spring 52 (see FIG. 3). Furthermore, in this case, the amplitude 104 of the opposing vibration 103, and its frequency 1/T are represented by their period duration T and their phase angle φ relative to the housing vibration 100.

FIG. 7 shows spring characteristics 111-115 of springs 52, 521-524 of different design, which can be used selectively in the vibratory means 58 of the electric tool 1 according to the invention.

The magnitude of the force [in N] with which the spring 52, 521-524 is stretched is plotted on the vertical axis 106, and the lengthening [in mm] caused by the stretching is plotted on the horizontal axis 105.

The spring characteristic 111 exhibits a linear profile, the spring characteristic 112 exhibits a constant profile, the spring characteristic 113 exhibits a non-continuous rise, the spring characteristic 114 exhibits a degressive profile, and the spring characteristic 115 exhibits a progressive profile.

A non-continuous rise 113 can be achieved, for example, by the parallel connection of two springs 521-524 as shown in FIG. 2, or by appropriate leaf springs. By way of example, a degressive or progressive profile 114, 115 can be achieved by appropriate winding of the springs 52, 521-524.

In the case of the vibratory means 58, the amplitude 104, the phase angle φ and/or the frequency 1/T of the opposing vibration 103 produced with the vibratory means 58 can be changed, such that the effective frequency range of the vibratory means 58 is increased. Since, in the case of the electric tool 1 according to the invention, a change to or adaptation of the opposing vibration of the vibratory means 58, which is intended to compensate for the housing vibration 100, is provided during operation of the electric tool 1, to be precise by the amplitude 104, the phase angle φ and/or the frequency 1/T of the opposing vibration 103 of the vibratory means 58 being changed, it is possible to very effectively compensate for the housing vibration 100 of the electric tool 1.

Furthermore, the opposing vibration 103 of the vibratory means 58 of the electric tool 1 according to the invention can also be adapted dynamically, thus allowing it to be changed both as a function of the instantaneous operating state of the electric tool 1 and independently of the operating point of the electric tool 1.

1. An electric tool, comprising:
a vibratory member configured to exert an opposing vibration which counteracts a housing vibration of the electric tool,
wherein a vibration-relevant characteristic of the vibratory member can be adapted during operation of the electric tool such that one or more of an amplitude, a phase angle and a frequency of the opposing vibration is varied in the event of a change in the vibration-relevant characteristic.

2. The electric tool as claimed in claim 1, wherein the electric tool has a change member configured to change the one or more of the amplitude, the phase angle and the frequency of the opposing vibration during operation of the electric tool.

3. The electric tool, as claimed in claim 1, wherein the housing vibration can be compensated for both as a function of an instantaneous operating state of the electric tool and independently of an operating point of the electric tool.

4. The electric tool, as claimed in claim 2, wherein the vibratory member has a natural frequency which can be changed by the change member in the electric tool.

5. The electric tool as claimed in claim 1, wherein the vibratory member has a mass which can be changed.

6. The electric tool as claimed in claim 5, wherein the mass comprises at least two mass elements which can be reversibly coupled to one another by the change member.

7. The electric tool as claimed in claim 1, wherein the vibratory member has a spring constant which can be changed by the change member.

8. The electric tool as claimed in claim 1, wherein the vibratory member has a spring characteristic which is non-linear.

9. The electric tool as claimed in claim 5, wherein the mass is arranged on at least one spring.

10. The electric tool as claimed in claim 8, wherein the vibratory member has a plurality of springs, which are connected to one another such that the spring characteristic of the vibratory member is non-linear.

11. The electric tool as claimed in claim 9, wherein the vibratory member has at least one second spring which interacts with the at least one spring on which the mass is arranged as a function of the amplitude of the opposing vibration.

12. The electric tool as claimed in claim 1, wherein the vibratory means member has a spring prestressing that can be changed by the change member.

13. The electric tool as claimed in claim 9, wherein the at least one spring of the vibratory means is borne at a bearing point, that is configured to be shifted by the change member.

14. The electric tool as claimed in claim 9, wherein the change member includes an electrical actuator which interacts with one or more of the mass and the spring.

15. The electric tool as claimed in claim 1, wherein the electric tool includes a detection member configured to detect the housing vibration of the electric tool or further vibration-relevant variables.

16. A method for compensating for a housing vibration of an electric tool, comprising:
using a vibratory member to exert an opposing vibration which counteracts the housing vibration of the electric tool,
wherein a vibration-relevant characteristic of the vibratory member can be adapted during operation of the electric tool such that one or more of an amplitude, a phase angle and a frequency of the opposing vibration is changed during operation of the electric tool.
